(19) United States
(12) Patent Application Publication
(10) Pub. No.: US 2016/0055250 A1
(43) Pub. Date: Feb. 25, 2016

(54) Real Time Relevancy Scoring System for Social Media Posts

(71) Applicant: Earshot, Inc., Chicago, IL (US)

(72) Inventor: David Rush, Winnetka, IL (US)

(73) Assignee: Earshot, Inc.

(21) Appl. No.: 14/830,716

(22) Filed: Aug. 19, 2015

Related U.S. Application Data
(60) Provisional application No. 62/038,837, filed on Aug. 19, 2014.

(51) Int. Cl. G06F 17/30

(52) U.S. Cl. CPC G06F 17/30867; G06F 17/30554; G06F 17/3053

(57) ABSTRACT

A computer-implemented method performed by a processor for identifying social media posts relevant to a user, the method including the steps of receiving a first plurality of variable weights from a first user and a second plurality of variable weights from a second user, wherein each variable weight corresponds to a variable of a set of variables, receiving, from a social media feed, a social media post of a social media user, calculating, for the social media post, a first relevancy score using a scoring algorithm with the first plurality of variable weights as an input, calculating, for the social media post, a second relevancy score using a scoring algorithm with the second plurality of variable weights as an input, providing, via a user interface, the first relevancy score to the first user, and the second relevancy score to the second user.

### CROSS-REFERENCE TO RELATED APPLICATIONS

This application incorporates by reference and claims the benefit of priority to U.S. Provisional Application 62/038,837, filed on Aug. 19, 2014.

### BACKGROUND OF THE INVENTION

The present subject matter relates generally to a system for generating real-time relevancy scores for social media posts. More specifically, the present invention provides a system that provides real-time relevancy scores for social media posts based on the content of the social media posts in context of dynamic, real-time adjustable, unique scoring algorithms.

Social media is a powerful force in business marketing. Platforms such as Twitter allow consumers to communicate directly with companies, or broadcast their thoughts on a business to a larger audience. Furthermore, these platforms are a vehicle for consumers to post their general feelings and views about a wide variety products and services, as well as details about their interests, activities, and location. The real-time nature of social media posts can provide additional insight as to the immediate conditions and feelings being experienced by the social media user. Not only is it crucial that businesses maintain a presence on social media, it is also important that they monitor social media to reach their ideal consumers at the time the customers are most receptive to being reached.

However, identifying valuable customers is easier said than done. There are obvious social media updates that explicitly call out to companies requesting interaction, but the relevancy of most user posts to a given business is not always readily apparent. There are a multitude of variables that can be read to determine how likely a social media user is to respond to a company's marketing efforts, and gaining the right insight from the post can be a daunting task.

One rudimentary method for identifying potential consumers is to simply wait for them to reach out to the company specifically. This approach under-utilizes the marketing benefits of social media, and it ignores many potential consumers.

In many cases, customers do not reach out to a company specifically for their needs. Indeed, it may be the case that a company's target consumers are unaware of the company's existence, or the company's potential benefit to them. And so, at a minimum, the company must do some detective work to find the consumers that are interested in the company's goods and services. This search could be based on words or hashtags within posts that identify certain goods or brands. Without an efficient system for dynamic prioritization and filtering, it can be overwhelming or even impossible to sort through the large number of social media posts that may be identified by keyword and hashtag searching.

Beyond the basic question of desirability of their goods and services, companies must separate their potential consumers from the larger pool of consumers with the same need. For example, a retailer with brick and mortar locations only in the Midwest would have a lesser likelihood of success with a consumer on the West Coast. As another example, a service industry company with extensive bookings may be better served identifying consumers with future, rather than immediate, needs.

Further complicating the search for target consumers is the nuances of tone, or sentiment, in social media posts. Consumers approach their needs in both the retail and service industry from a variety of perspectives. Some consumers are excited about their perspective purchases, while others see shopping/seeking out services as a chore. Consumers may communicate their feeling of frustration at not being able to find the right product or services, and these sentiments may instruct companies on how and when to reach out to the consumer, if at all. The consumer sentiments may also provide further context to what the consumer is most likely to respond to. For example, sentiments about the cost or quality of certain products and services may reveal to companies whether they are likely have success with a particular consumer. Luxury shoe brands may not reach out to consumers who discuss bargain hunting, but a discount shoe retailer might. Likewise, fast-food chains may target social media users who have expressed positive views on hamburgers and not social media users who emphasize healthy eating.

A strategy for responding to potential consumers must also consider the identity of the social media user. Companies may choose to prioritize their responses based on who the social media user is. For example, by targeting more influential social media users, companies may pave the way for word-of-mouth marketing, or they may persuade the social media user to specifically refer to the company. For this reason, companies must consider the factors that determine a social media user's influence, such as whether the social media user has a verified account, how many followers the social media user has, and how many people share the social media user's posts.

Influence, however, is not the only metric to determine the relevancy of the social media user. Companies may value the social media user's history and background as much or more so than the social media user's influence. For example, social media users who participate in sporting events may be more relevant to running shoe companies than non-athletic social media users who have a high follower number.

As shown, there are a myriad of variables that can and should be considered by companies vis-à-vis potential customers using social media. In many instances, these variables retain their relevancy to companies even if the social media user has not explicitly indicated a need for a product or service. A comprehensive social media strategy should therefore consider the relevancy of posts even if the post is not directed towards the need for a product or service.

Social media users may be targeted according to events they are participating, where they are located at the moment of the post, or what is happening around the social media user. A restaurant may wish to reach out to a consumer solely on the basis that the consumer is in the vicinity of the restaurant. Similarly, sporting goods stores may reach out to social media users who have indicated their presence at a fishing competition. An umbrella manufacturer may wish to contact anyone who posts about rainy weather.

Identifying relevant variables, however, is not always cut and dry. Sometimes events must be inferred from location. For example, a social media user may post that they are at a park that is the location of a music festival, but they will not indicate that they are at the music festival. Companies that consider music festivals relevant must see that the social media user is in the relevant location at the relevant time in order to identify the music festival presence. This is one example of how seeing the significance of variables is essential to gaining an accurate relevancy assessment.

Taking this idea further, companies may even benefit from inferring needs based on two or more variables. For example, an orthotics manufacturer might reach out to individuals of a certain age who posted about their experiences seeing a podiatrist. An eco-friendly car company might reach out to a social media user who has expressed concern for the environment and frustration with public transportation. An outerwear retailer might contact individuals in colder climates who enjoy the outdoors.

Because the content of social media posts can be so revealing to companies, it is important not only that they see the posts that are relevant to them but also that they are able to gauge the relevance and respond to the post in a timely manner with an appropriate response action. The first step to gauging relevance is to determine which variables are most important to a company, and give greater weight to those variables. But for marketing personnel within companies, applying weighted relevancy assessments is too complex a process to be completed efficiently. Further, the task of determining appropriate response actions may be too time-consuming for companies to include as part of a marketing strategy. This may lead to a one-size-fits all approach to response actions, which defeats the purpose of using a variable-centric outreach strategy.

The difficulties in marketing to social media posts are therefore many-fold. Companies must identify relevant social media users based on numerous variables for relevancy, some of which may be inferred from other variables, then they must identify the most promising customers by weighting their variables, and finally they must determine which customers they would like to reach out to and how they would like to contact them. As a final challenge, this entire process needs to be completed as fast as possible in order to reach out to the customers at the right time and maintain a competitive edge.

Accordingly, there is a need for a system and method for analyzing social media posts in relation to their relevancy on a number of variables, producing a relevancy score based on how the post responds to each variable and how important the variable is, and identifying both the worthy recipients and appropriate nature for response actions, as described herein.

### BRIEF SUMMARY OF THE INVENTION

To meet the needs described above and others, the present disclosure provides a real time relevancy scoring system for analyzing social media posts in relation to their relevancy on a number of variables, producing a relevancy score based on how the post responds to each variable and how important the variable is, and identifying posts worthy of a response and an appropriate nature for response actions.

By providing a system for weighing important variables and then automatically ranking posts along those variables in real-time, the system enables a user, such as a brand manager or marketer to identify relevant social media posts with which to engage through social media. The user may begin by configuring a campaign with custom variable weights and custom sub-variables defining the variables. A variable may be defined when the user, or an administrator of the system selects various sub-variables that will contribute to each variable. The user may then provide weights for each variable and a threshold for triggering notifications.

As described throughout the disclosure, a user is someone that configures an algorithm or a campaign for scoring social media posts. As used herein, a user may be a brand (i.e., company), a brand manager (e.g., social media manager for company), or even simply the campaign itself (i.e., the scoring algorithm itself is the user of the system in that it uses the social media feed to create a real-time index of relevant social media posts).

The system receives social media posts of consumers through feeds from one or more social networks. To calculate a relevancy score for a post, the relevancy scoring system may begin with raw inputs and use the raw inputs to determine various sub-variable values that, in turn, may be used to calculate various variable values. Raw inputs may include the post itself, the consumer profile, the consumer's influence data, the consumer's location, and conditions data. Sub-variables may include a large variety of conditional filters and measurements of the raw data, such as sentiment measures, consumer personality measurements, number of followers, distance to places of interest, and the weather or events near the consumer. The sub-variables may, in turn, be used to determine values for a set of variables.

The examples used herein often include a description of the interplay between various variables and sub-variables. These descriptions are intended to convey that not all variables are of equal importance and that sometimes groups of variables (i.e., sub-variables) may be used to support the value of a superior variable (i.e., variable). However, it is understood that not all embodiments will make use of a variable hierarchy or that there is any reason one or more variables must be supported by sub-variables. It will be understood by those skilled in the art that the solutions presented herein do not require the use of sub-variables.

In an embodiment, a set of variables may include a person variable, an influence variable, a post variable, a location variable, and a conditions variable. As noted, the variables may have associated weights provided by the user. The relevancy scoring system may calculate the relevancy score by summing the value of the variables after each variable is weighed by its corresponding weight. If the relevancy score exceeds a threshold, the user may be notified of the post via a notification. To assist the user in responding to posts, the relevancy scoring system may suggest recommended responses tailored to that consumer.

In a primary example of the systems and methods described herein, as social media posts are captured in the system, a dynamic algorithm is applied to compute a real-time relevancy score between 0.1 and 9.9 for every post. The scoring algorithm is uniquely weighted based on the variables and specific targeting interests of the brand or campaign and is customizable as filtering interests change. Brands can adjust variables such as location, keywords, personality traits, follower count, etc. in real-time to “tune” into what is most important to them at that moment in time and use the real-time score to filter social media in a smarter way.

Armed with this new insight, users are able to leverage and re-apply the real-time scoring data to organic or more targeted programmatic campaigns. As real-time conditions change, so too does the real-time scoring data, so that elements such as weather, mood, season, or events make the score dynamic for every moment and unique to every brand.

With location details, the system and methods described herein are able to route posts to the local level for real-time engagement and intelligence. Mapping the coordinates of each post with the business rules of each client, the systems and methods disclosed herein can empower users with the real-time insight to take action offline when the impact is greatest.

In an embodiment, a computer-implemented method performed by a processor for identifying social media posts relevant to a user includes the steps of receiving a first plurality of variable weights from a first user and a second plurality of variable weights from a second user, wherein each variable weight corresponds to a variable of a set of variables, receiving, from a social media feed, a social media post of a social media user, calculating, for the social media post, a first relevancy score using a scoring algorithm with the first plurality of variable weights as an input, calculating, for the social media post, a second relevancy score using a scoring algorithm with the second plurality of variable weights as an input, providing, via a user interface, the first relevancy score to the first user, and the second relevancy score to the second user.

In an embodiment, the method further includes receiving a relevancy score threshold from the first user, and when the relevancy score threshold exceeds the first relevancy score, notifying the first user of the social media post. In an embodiment, the scoring algorithm calculates the first relevancy score by summing products of a value of each variable multiplied by the variable weight corresponding to the variable.

In an embodiment, the set of variables includes a post variable derived from content of the social media post, a location variable derived from a location of the social media post, and an influence variable derived from social media interactions of the social media user.

In an embodiment, the set of variables includes a post variable derived from content of the social media post, a location variable derived from a location of the social media post, an influence variable derived from social media interactions of the social media user, and a person variable derived from a social network profile of the social media user, and a conditions variable derived from one or more conditions at the location of the social media post.

In an embodiment, a value of the post variable is increased in response to a presence of a keyword in the social media post. In another embodiment, a value of the post variable is increased relative to a sentiment of the post. In yet another embodiment, a value of the location variable is increased relative to a distance between a pre-determined location and the location of the social media post. In a further embodiment, a value of the influence variable is increased relative to a number of followers of the social media user. In an even further embodiment, a value of the person variable is increased in response to a profile of the social media user matching a personality type. In yet another embodiment, a value of the conditions variable is increased in response to weather at the location of the social media post.

In an embodiment, the method further includes the step of providing a recommended response for the social media post. In an embodiment, the recommended response includes a recommended category of response. In an embodiment, the recommended response includes a recommended text example. In an embodiment, the recommended response includes a predicted rate of success of a response.

In an embodiment, each of the first plurality of variable weights received from the first user and the second plurality of variable weights received from the second user are independently adjustable in real-time. In an embodiment, the social media feed comprises any selection of posts from a social media platform.

An object of the systems and methods described herein is to analyze the real-time relevancy of social media posts using a number of user defined and user adjustable variables.

Another object of the systems and methods described herein is to identify social media posts to which a brand may respond for marketing and consumer relations.

A further objective of the systems and methods described herein is to assist brands in finding the right customers with whom to engage at the right place and at the right time.

An advantage of the systems and methods described herein is that they give marketers a real-time stream of relevant, scored social media posts and the tools to engage with the social media users when timing can be the difference between winning and losing new customers. The systems and methods give users the tools to go beyond the post and filter on everything from social influence to personality type and be notified when someone of relevance is at the right place, right time and ripe for real-time engagement.

Another advantage of the systems and methods described herein is that they help brands and their agencies minimize waste and activate more targeted social media campaigns at scale. The systems and methods help users optimize social media ad spend by not only driving higher engagement and traditional CTR metrics, but by also capturing more earned media through the sharing of more compelling, contextual content. Users can activate campaigns to reach people within a specified radius of locations of interest like stores, stadiums, or airports.

A further advantage of the systems and methods described herein is that they open up an entirely new way to tap into individual events or categories of events for real-time engagement or intelligence. Whether users are interested in a specified business convention or every MLB game from the first pitch to the last out, the systems and methods described herein provide the lens into real-time conditions (weather, score, etc.) that allow users to connect with audiences who are in the midst of an experience that's relevant to your brand.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates an example of a relevancy scoring system.

FIG. 2A illustrates a social media post as may be viewed by a user through a user interface of the relevancy scoring system of FIG. 1.

FIG. 2B illustrates a score breakdown popup box of the relevancy scoring system that illustrates the components of a relevancy score of the relevancy scoring system of FIG. 1.

FIG. 3 is a diagram illustrating the general flow of information when the relevancy scoring system of FIG. 1 calculates the relevancy score.

FIG. 4 is a new campaign screen of a user interface that permits a user to define a campaign by adding or removing sub-variable from each of the variables.

FIG. 5 is a weight input screen of a user interface that permits a user to weight each of the variables of the campaign.

FIG. 6 is a campaign screen that permits a user to view highly relevant social media posts related to the campaign in real time.

FIG. 7 is an example consumer communications screen that permits a user to view and respond to a post using profile information of the consumer and suggested response provided by the relevancy scoring system of FIG. 1.

FIG. 8 is a flowchart demonstrating a relevancy scoring method of the relevancy scoring system of FIG. 1.

### DETAILED DESCRIPTION OF THE INVENTION

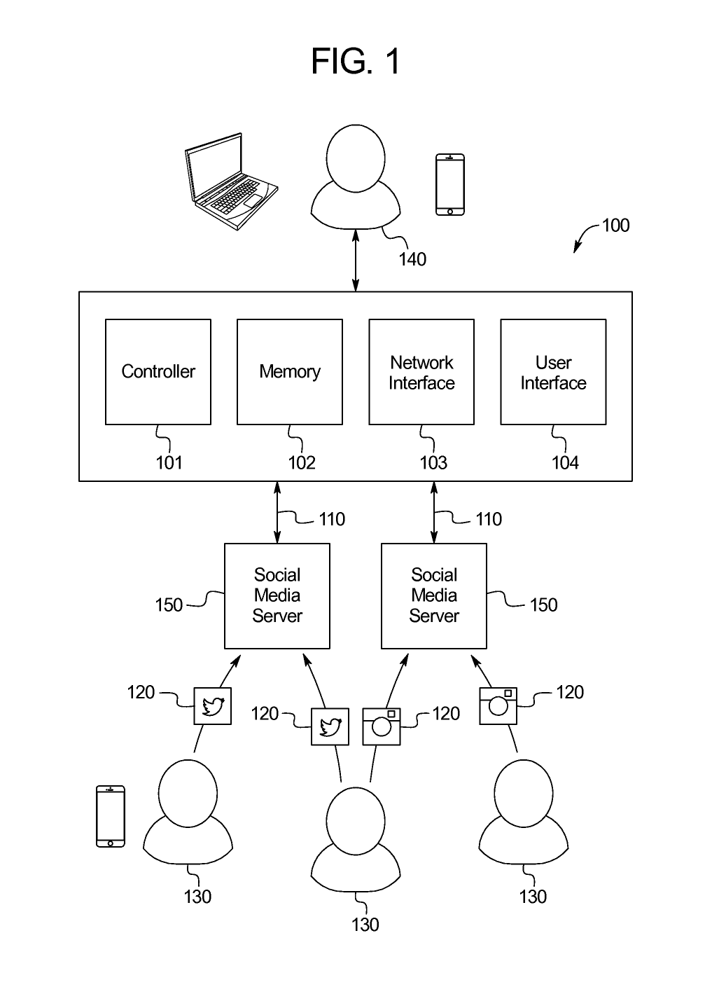

FIG. 1 illustrates an example of a relevancy scoring system 100. As shown in FIG. 1, the relevancy scoring system 100 receives social media posts 120 of consumers 130 through feeds 110 from one or more social networks 150. A user 140, such as a marketer or social media manager, may use the relevancy scoring system 100 to identify posts 120 that are highly relevant based on the user's needs. For each post 120, the relevancy scoring system 100 may suggest various appropriate response actions that the user 140 may use to respond to the post 120.

To carry out its tasks, the relevancy scoring system 100 may include a controller 101 that executes instructions stored in a memory 102. The controller 101 may receive data, such as feeds 110, from the social networks 150 via a network interface 103. To communicate with the user 140, the relevancy scoring system 100 may include a user interface 104. In an embodiment, the user interface 104 may be a web application that may accessed by user devices of the user 104.

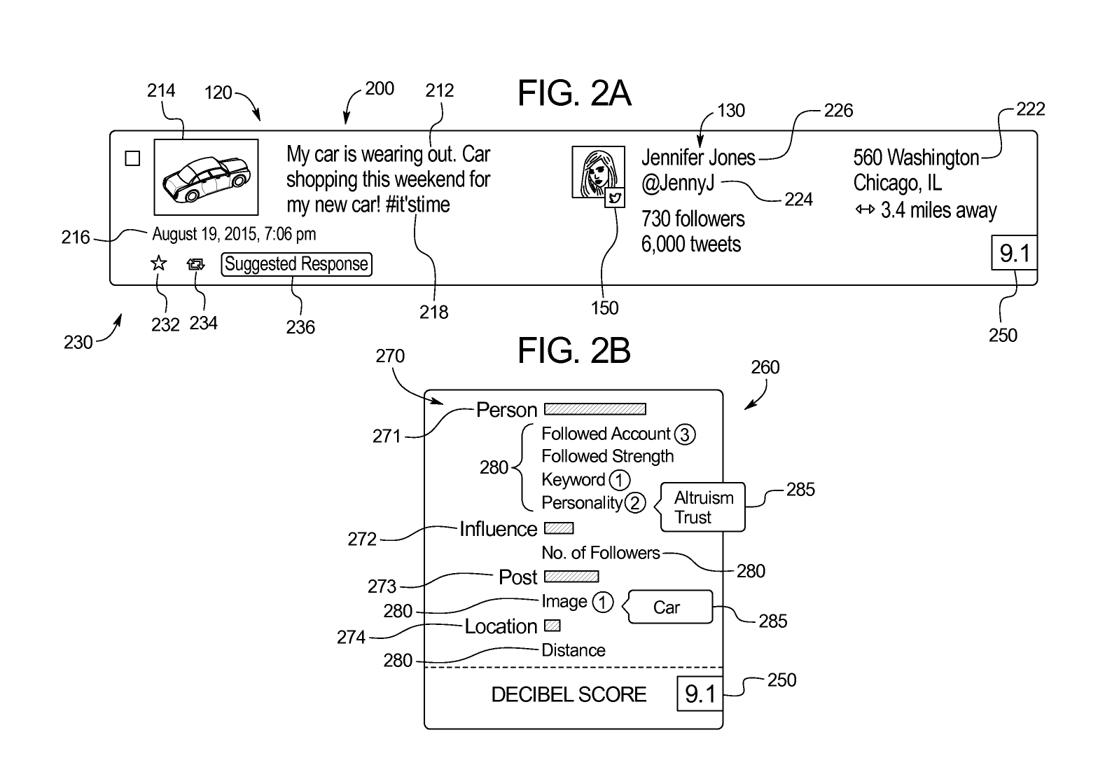

To provide a motivating example, the figures herein use the example of a car brand looking to connect with consumers 130. The example user 140 is a marketer working for the car brand that desires to locate and connect with consumers 130 who may be interested in purchasing a car of the car brand, or who fits a desired profile for a promotion being run by the car brand. FIG. 2A illustrates a post 120 with a high relevancy score 250 that may be of interest to the example user 140. FIG. 2B illustrates a breakdown of the relevancy score 250 along various variables 270 and sub-variables 280.

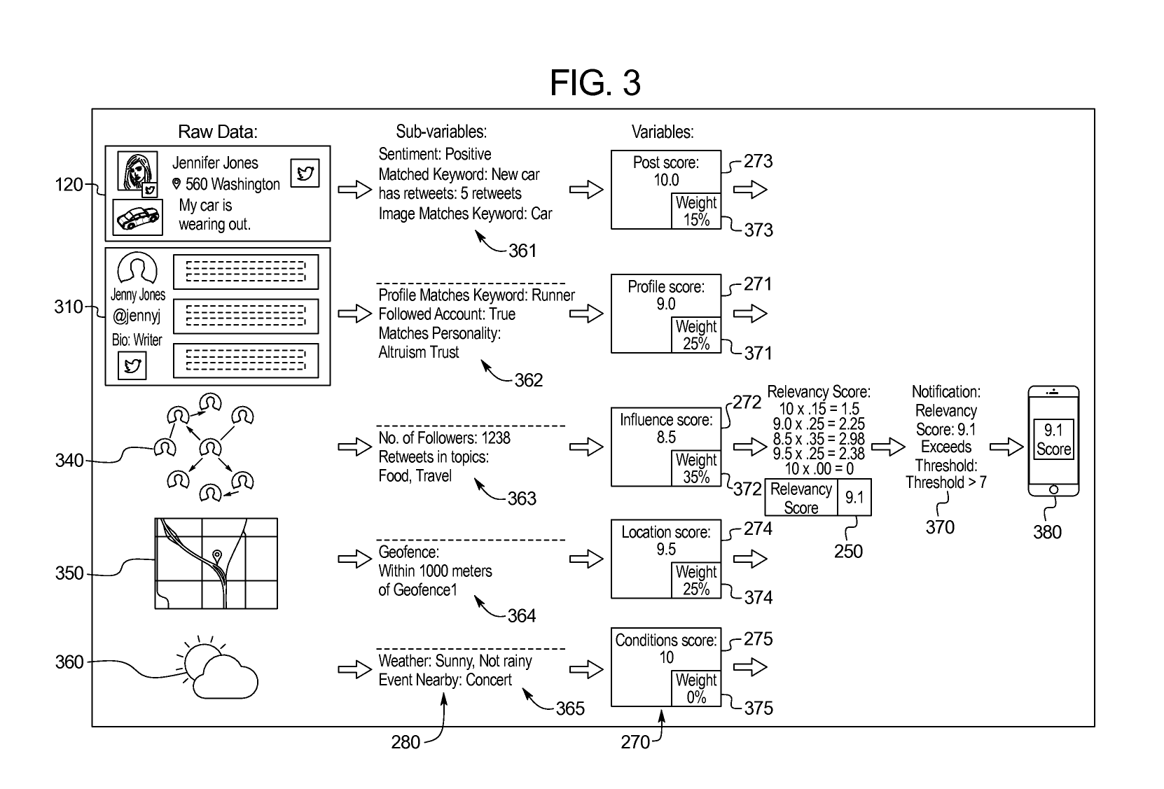

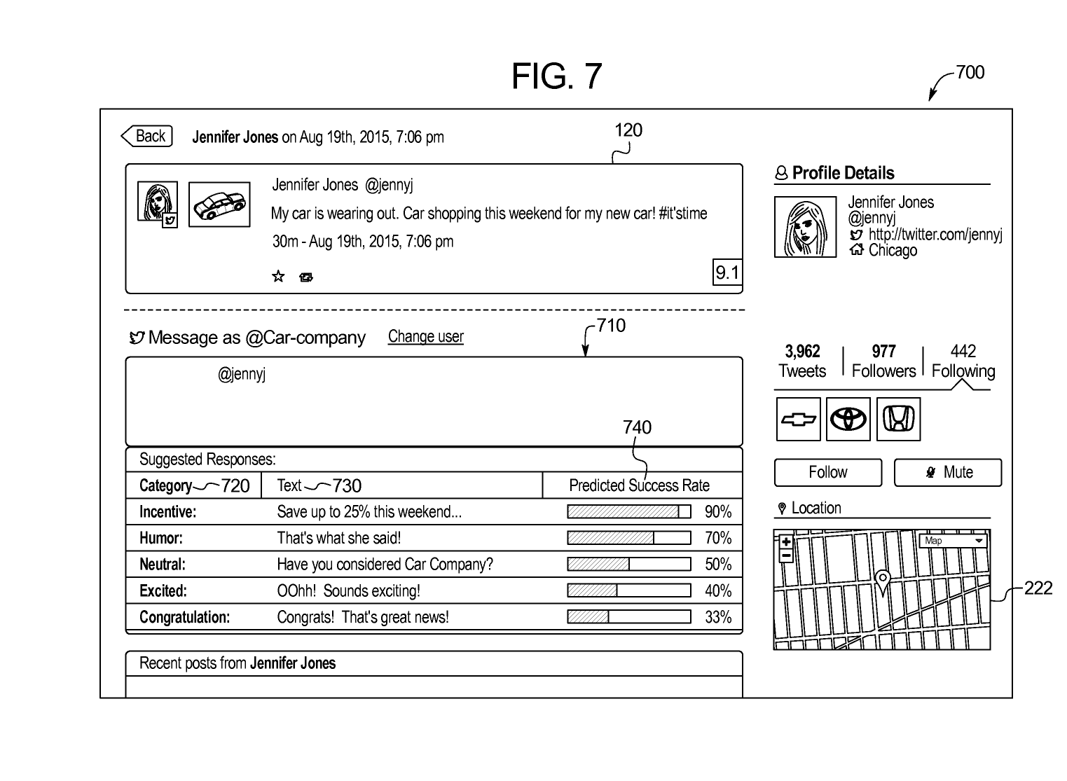

As shown in FIG. 3, when calculating the relevancy score 250 for a post 120, the relevancy scoring system 100 may begin by receiving raw inputs, such as post 120 itself, the consumer profile 310, influence data 340 regarding the consumer 130, the consumer's location 350, and conditions data 360. The raw inputs may be used to determine various sub-variables 280 that, in turn, may be used to calculate various variables 270. In an embodiment, a set of variables 270 may include a person variable 271, an influence variable 272, a post variable 273, a location variable 274, and a conditions variable 275. The variables 270 may have associated weights provided by the user 140. The relevancy scoring system 100 may calculate the relevancy score 250 by summing the variables 270 after each variable 270 is weighed by its corresponding weight. If the relevancy score 250 exceeds a threshold 370, the user 140 may be notified of the post 120 via a notification 380. To assist the user 140 in responding to posts 120, the relevancy scoring system 100 may suggest recommended responses 710 (FIG. 7) tailored to that consumer 130.

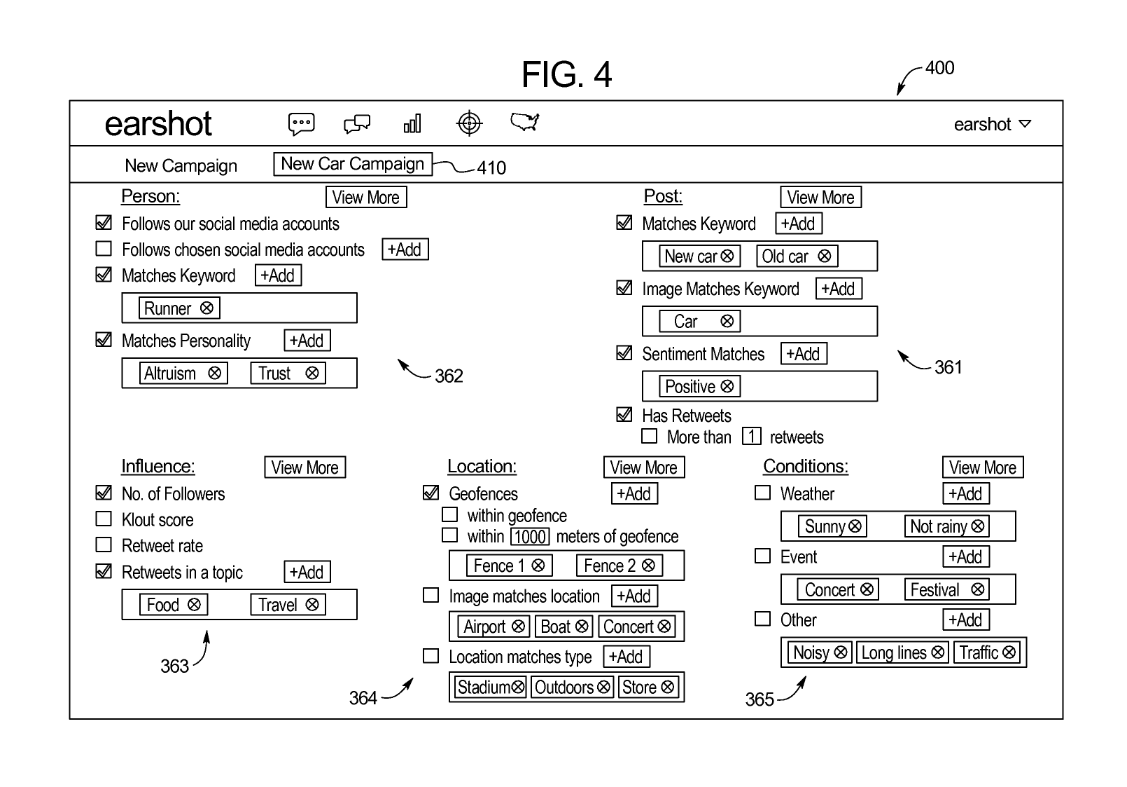

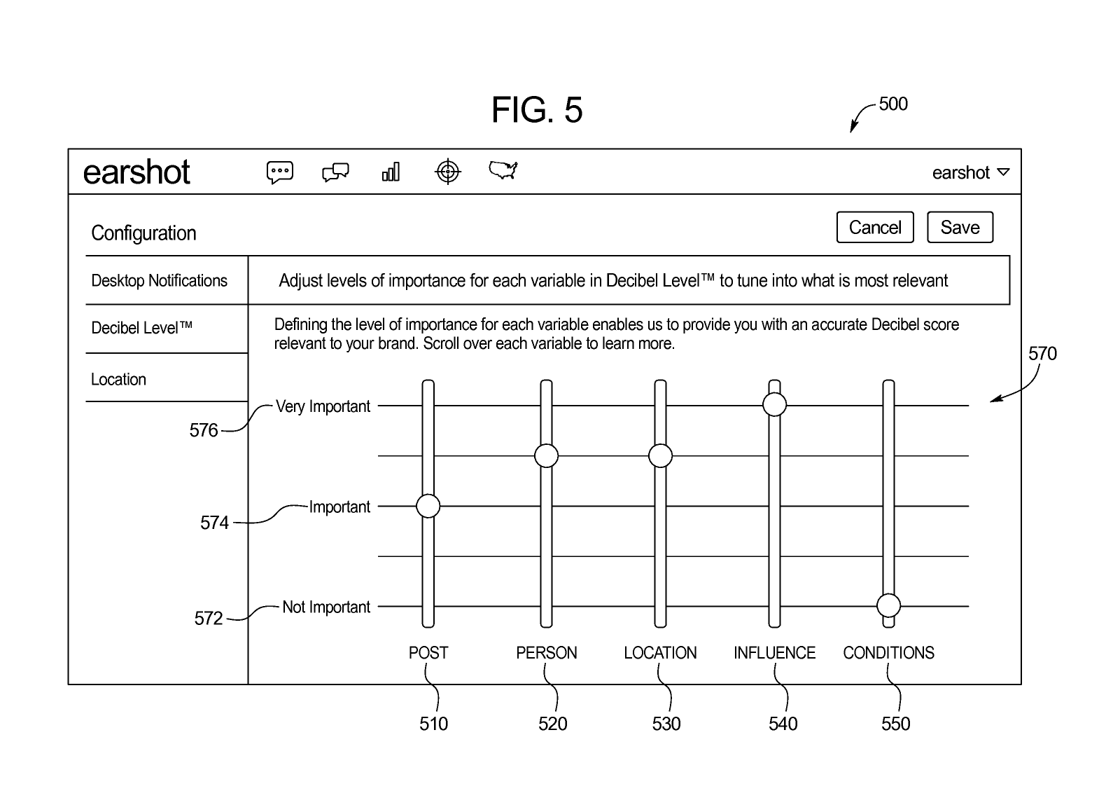

The relevancy scoring system 100 is designed to have relevancy scores 250 that are customized to the user's needs. Accordingly, as will be shown with respect to FIGS. 4-6, the user 140 may configure a campaign 410 with a custom variable weights and custom sub-variables 280. As shown in FIG. 4, to create a campaign, the user 140 may first select various sub-variables 280 that will contribute to each variable 270 using a new campaign screen 400. Then, as shown in FIG. 5, the user 140 may provide weights for each variable 270. To view the highly ranked posts 120, the user 140 may access a campaign screen 600. The campaign screen 600 may permit the user 140 to set a threshold 370 and activate notifications 380.

Returning to FIG. 2A, shown is a highly relevant post 120 that may be of interest to the user 140. The user may view the post 120 through the user interface 104 of the relevancy scoring system 100. The post 120 may include media 210 such as post text 212, images, 214 video, links, hashtags 218, references to other users, information linking the post to other posts and users, metadata, etc. Metadata of a social media post 120 may include the time 216 of the post 120, the location 222 of the post 120, the social network 150 of the post, the username 224, a handle, a real name 226 of the user, etc. As shown, when displaying a social media post 120, the user interface 104 may additionally display the calculated relevancy score 250 for the post 120.

The user interface 104 for a post 120 may include response actions 230 that the user 140 may make in response to the post 120. As shown in FIG. 2A, the response actions 230 may include a star button 230 to star the post on the social network 150. For some posts 120, instead of a star button 230, the user interface 104 may include a like button, upvote button, pin button, etc., based on the functionality provided by the social network 150. Additionally, the response actions 230 may include a re-share button 234 to re-share (e.g., re-tweet, re-blog, etc.) the post 120 on the network under the user's account. Further, the response actions 230 may include a suggested response button 236 to permit the user to view suggested responses and make a suggested response as further shown in FIG. 7.

Turning to FIG. 2B, illustrated is a score breakdown popup box 260 displayed by the user interface 104 of the relevancy scoring system 100 that illustrates the components of a relevancy score 250. The score breakdown popup box 260 may be displayed whenever a user 140 moves the cursor over a displayed relevancy score 250, such as the relevancy score 250 in FIG. 2A. As shown, the score breakdown popup box 260 may display each of the variables 270 included in the calculation of the relevancy score 250, such as, the post variable 273, the person variable 271, the influence variable 272, the location variable 274, and the conditions variable 275 (FIG. 3). For each of the variables 270, the score breakdown popup box 260 may display sub-variables 280 that affected the relevancy score 250. The user 140 may hover the cursor over a sub-variable 280 to view additional information 285, such as, the keywords used in a sub-variable 280.

FIG. 3 is a diagram illustrating the general flow of information when the relevancy scoring system 100 calculates the relevancy score 250. As shown, when scoring a single post 120, the relevancy scoring system may receive several raw inputs, such as post 120 itself, the profile 310 of the consumer 130 associated that made the post 120, influence data 340 regarding the consumer 130, the consumers location 350, and conditions data 360.

The raw inputs from the profile 310 may include biographical information, links to other social media profiles of the user 140, past posts, links to websites associated with the user 140, etc. The raw inputs of the influence data 340 may include the number of followers or friends of the user 140, the number of re-shares (that is, re-tweets, shared posts, re-blogs, and other sharing of a user's posts by others) of the post and the user's past posts, the user's Klout score, re-shares of the user 140 in a topic, etc. The consumer's location 350 may include a raw GPS location in the metadata of a post 120, a raw GPS location of the consumer 130, or any other location information that may be received from the social networks 150. Conditions data 360 may include weather data received from a weather service, traffic congestion received from a traffic service, event information from event aggregators, and other condition information that may be derived from social networks 150 from consumers 130 near to the posting consumer 130.

The post variable 273 may be calculated from a variety of post sub-variables 361 derived from the social media post 120. For example, the post sub-variables 361 may include a determination of the sentiment of the post 120. Sentiment may be expressed either conditionally, such as positive sentiment, negative sentiment, or neutral sentiment, or as a real valued sentiment value. Additionally, the post variable 273 may include directed sentiment, that is, the positive or negative sentiment that is directed at an object. For example, the statement “Give me a burger over a salad any day!” expresses positive sentiment towards a burger and a negative sentiment towards a salad. The user 140 may configure how sentiment affects the post variable, for example, the campaign 410 may be configured to lower the post variable 273 for users 140 expressing negative sentiment for salads. In an embodiment, the sentiment determination may be provided by the Watson® computer system provided by IBM®.

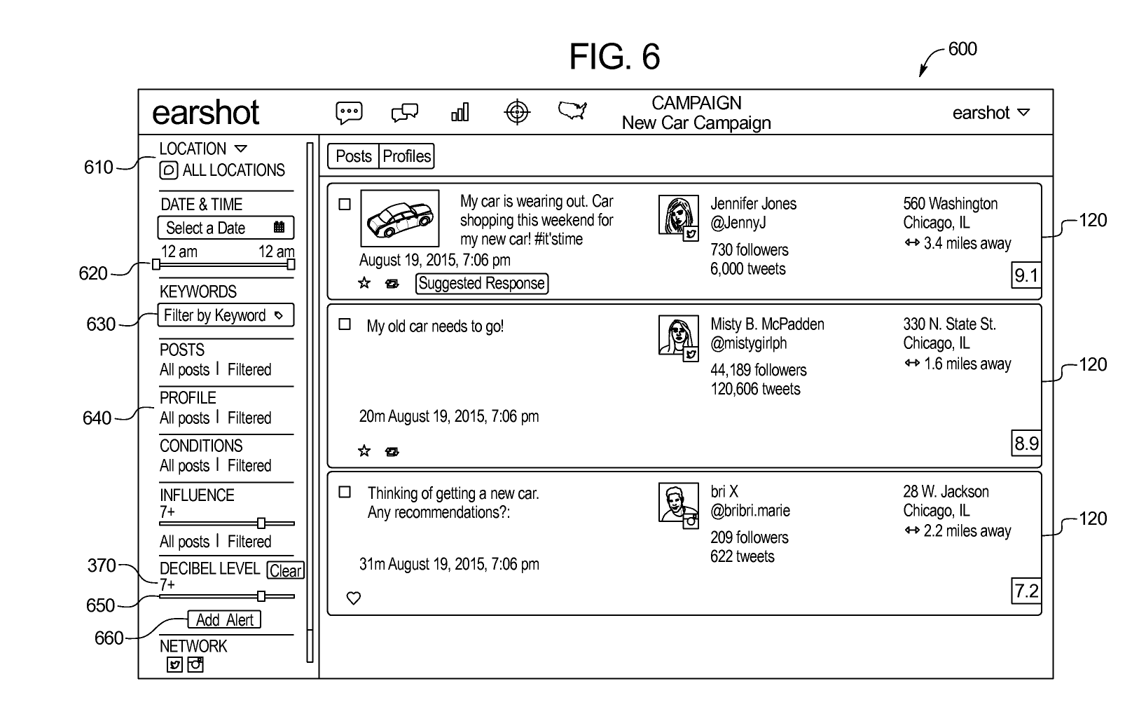

Additionally, the post variable 273 may include sub-variables measuring the “activity” of a post 120, such as re-tweets, replies, likes, etc. Moreover, the post variable 273 may take into account any reply or activity by the brand/retailer (e.g., replies, etc.) and subsequent conversations. Further, the post variable 273 may additionally be calculated from filters applied to the media 210 of the post 120. Filters may include keyword filters applied to the post text 212. Key word filters may be positive to match on the presence of a keyword or negative to match on the absence of a keyword. Additionally, keyword filters may be applied to images 214 and video using image recognition. An additional post filter may be a time-based filter in order to filter older posts that may be out-of-date and no longer relevant, as further shown in FIG. 6 with respect to the time slider 620.

The person variable 271 may be calculated from a variety of person sub-variables 362 derived from the profile 310 of consumer 130 who made the post 120. For example, the person sub-variables 362 may include a personality match or condition. The personality of the consumer 130 may be derived from information in the profile 310 including past posts of the consumer 130. The personality of the consumer 130 may be classified using the various personality models, such as the Big Five, Myers-Briggs, etc. The user 140 may create a campaign 410 that filters for particular personality types.

The person variable 271 may additionally be calculated from keyword filters applied to the consumer's bio, profile name, and other information in the profile 310. Additionally, the person variable 271 may be calculated from: the number, kind, and user names of that consumer 130 on other social media networks 150; the total number of posts 120 by that consumer 130 on other social media networks 150; when the consumer 130 joined the particular social media networks 150; etc. Further, the person variable 271 may be calculated from person sub-variables 362 such as: whether the consumer 130 is verified (such as “twitter-verified”) on a social media network 150; which accounts the consumer 130 follows, including detecting specific accounts; which accounts follow the consumer 130, including detecting specific accounts, including the decibel levels or a subset thereof, of those people; whether the consumer 130 is a member of the brand/retailer's loyalty program and if so, their status in the that program (e.g., premier members of United Airlines); the consumer's purchase history with the user 140 or competitors; whether the consumer 130 has “liked” the brand on Facebook; etc.

The location variable 274 may be calculated from a variety of location sub-variables 363 derived from the location of consumer 130 who made the post 120. For example, the location sub-variables 363 may include the actual or approximate location of the consumer 130 currently (this may come from the source social network, or other social networks that user is on) or the actual or approximate location of the consumer 130 when the post 120 was made. Additionally, the location sub-variables 363 may include whether the post 120 was made inside a particular area (a.k.a., a geo-fence). Moreover, the location sub-variables 363 may include a measure of how much total activity is taking place in that specific area. Further, the location sub-variables 363 may include the amount of activity that person generates from a specific geo-fenced area. For example, the location sub-variables 363 may include the distance of the post 120 or consumer 130 from specific places (e.g. “nearest retailer”), and the availability status (open, closed) of the specific places. Even further, the location sub-variables 363 may take into account the location of the consumer 130 over time (has the consumer 130 ever been in the geo-fence and other relevant geo-fences of interest).

The influence variable 272 may be calculated from a variety of influence sub-variables 364 derived the social media interactions of the consumer 130 who made the post 120. For example, the consumer sub-variables 364 may include: the number of followers that consumer 130 has associated with their network ID; the number of accounts that consumer 130 is following in each network; the total number of posts 120 or content by that consumer 130 on the source social network 150; and which consumers 130 liked, re-tweeted, or otherwise engaged with the post 120. Additionally, the influence sub-variables 364 may include: the ratio of a consumer's followers to follows; the ratio of the consumer's posts 120 to “posts with re-tweets”; the ratio of a consumer's total posts 120 to posts 120 that are relevant to the brand/retailer of the user 140; particular celebrity accounts that the consumer 130 is following; and the re-tweet activity of the consumer's followers.

The condition variable 275 may be calculated from a variety of condition sub-variables 365 derived from conditions in the proximity of the consumer 130 who made the post 120. For example, condition sub-variables 365 may include: the weather near consumer 130, the time of day, nearby events (country music concert, long lines, noisy conditions), the time of year and seasonal impacts thereof, etc.

Returning to FIG. 4, a new campaign screen 400 of the user interface 104 is shown. The new campaign screen 400 permits a user 140 to define a campaign 410 by adding or removing sub-variable 280 from each of the variables 270. As shown, the user 140 may define a campaign 410 by selecting sub-variables 280 for each variable.

FIG. 5 is a weight input screen 500 of the user interface 104 that permits a user 140 to weight each of the variables of the campaign. As shown, the weight input screen may include inputs for each of the variables, e.g., post input 510, person input 520, location input 530, influence input 540, conditions input 550. The inputs may be real-valued inputs in the form of sliders inputs. In an embodiment, various points along the slider may be demarcated as making the variable 280 one of: not important 572, important 574, and very important 576.

In the example use case shown in FIGS. 4 and 5, the user 140 is looking to highly rank posts where the consumer 130: for the person variable 271, the consumer 130 follows the user's social media accounts, matches a keyword (“runner”), and matches a personality (“altruism” or “trust”); for the post variable 273, the post 120 matches a keyword (“new car” or “old car”), has an image matching a keyword (“car”), has a positive sentiment, and has retweets; for the influence variable 272, increase relevancy based on the number of followers, and the number of retweets in a topic (“food” or “travel”); for the location variable 274, is within one thousand meters of a geofence (“Fence 1” or “Fence 2”); and, for the conditions variable 275, does not have any selected conditions for the conditions variable 275. As is in FIG. 5, the user 140 has ranked the post variable 273 as important, the person variable 271 as important to very important, the location variable 274 as important to very important, the influence variable 272 as very important, and the conditions variable 275 of no importance.

In another example, a running group may want to attract concert-goers who run to their booth at the concert by interacting with the concertgoers on a social media network 150. Accordingly, the running group may configure a conditions sub-variable 365 that targets consumers 130 at the event. The running group may additionally configure locations sub-variables 363 that target consumers 130 within one thousand meters of a geofence around the concert venue. To narrow the targeting to runners, the running group may additionally configure person sub-variables 362 that match the keyword “runner” in the profiles 310 of the consumers 130. To narrow targeting to highly influential consumers 130 at the event, the running group may configure influence sub-variables 364 that target consumers 130 with a high Klout score and retweet rate. Finally, the running group may configure post sub-variables 361 that match posts 120 with a positive sentiment, to find posts 120 of consumers 130 enjoying the concert to retweet. When ranking the variables, the running group may highly rank the location variable 274 and the conditions variable 275 to ensure that only consumers 130 are highly relevant; all other variables 270 may be set at important.

In another example, a bank may wish to respond promptly to customer complaints about its service on social media. In order to find customers 130 that are upset, the bank may configure a post-sub-variable 120 that matches posts with a negative sentiment towards the bank. Additionally, the bank may configure a post-sub-variable that includes a filter match for the bank name, the word “bank”, the word “service” and other words likely to be in a complaint about the bank. Because the bank name may not necessarily be used, the bank may additionally find upset consumers 130 by adding location sub-variables that match consumers 130 within geofences defining the bank's branches. Even further, the bank may include person sub-variables 362 to match consumers' profiles 310 to a list of known customer profiles 310. To exclude customers 130 with unrelated complaints, such as complaints about the weather, or traffic, the bank may configure conditions sub-variables 365 to exclude consumers 130 in areas with rainy conditions, bad traffic conditions, noisy conditions, etc. Finally, to prioritize customers 130 that have a large audience to complain to, the bank may set the influence sub-variables 364 to include the consumers' number of followers. When ranking the variables, the bank may initially rank each of the variables 270 as important to create a balanced view of posts 120 that may contain possible complaints.

As may be understood from the examples, the value of each variable 280 for a post 120 may be calculated by combining sub-variables 270. Sub-variables 270 may, among other things, be binary or real valued. For example, matching a keyword is a binary sub-variable 270—either the keyword is present or it is not. Conversely, the distance from the consumer 130 to a geo-fence is a real-valued measurement—the distance can be any number. To permit calculation, binary sub-variables 270 may be assigned a real value before being combined with real-valued sub-variables 270. For example, the binary sub-variable 270 of a matched keyword may be assigned a value of one, while an un-matched keyword may be assigned a value of zero. In this way, all sub-variables 270 may be mathematically combined to produce variables 280.

In an embodiment, the sub-variables 270 may be weighted by sub-variable weights when calculating a variable 280. By weighing the sub-variables 279, the relevancy scoring system 100 may favor highly informative sub-variables 270 over sub-variables providing only a modest information gain. Sub-variable weights may be provided by the user 140 or be provided by the relevancy scoring system 100. In an embodiment, the user 140 may provide the sub-variable weights via slider inputs when setting up a campaign 410. In another embodiment, the sub-variable weights 270 may be learned by the relevancy scoring system 100 via feedback from the user 140.

For example, in an embodiment, the user 140 may provide feedback per-post. In such an embodiment, the relevancy score 250 for a campaign 410 may be initially calculated using default sub-variable weights. The user 140 may then review the top-scoring posts 120 and positively indicate “more like this” or negatively indicate “less like this” for each post. The sub-variables 270 of the positively indicated posts 120 may then have their sub-variable weights increased, while the negatively indicated posts may have their sub-variable weights decreased. It is contemplated that the sub-variable weights may be shared across campaigns 410; for example, the feedback received in multiple campaigns 410 may be used to calculate default sub-variable weights.

FIG. 6 is a campaign screen 600 that permits a user 140 to view highly relevant social media posts 120 in real time. The user 140 may view campaign variables 2700 and other criteria in a column on the left of the campaign screen 600. The highly ranked posts 120 may limited to a particular location using a location selector 610, or may be viewed for all locations. Additionally, the user 140 may use a time slider 620 to limit the age of the posts 120 that are being displayed.

The campaign screen 600 may further permit the user 140 to filter posts 120. The user 140 may enter keywords into a keyword input 630. In an embodiment, an entered keyword may be applied to a variable 270 to permit re-ranking In another embodiment, an entered keyword may be applied after ranking to narrow the number of returned posts 120. The user 140 may toggle keyword filters using one or more filter toggles 640. In an embodiment, filter toggles 640 may be provided per variable 280. For example, the user 140 may toggle the post variables 273 from “filtered” to “all posts” to relax ranking along a the post variable 273 to surface posts 120 of a different character or to view the consequences of sorting using that particular variable.

The user may additionally use a threshold input 650 to limit the displayed post 120 to being greater than the provided threshold 370. The threshold 370 may additionally be used to trigger notifications by clicking an add alert button 660.

Turning to FIG. 7, for posts 120 that have been notified to the user 140, the system 100 may make recommendations regarding the response. For example, as shown in the consumer communications screen 700 of FIG. 7, a plurality of recommended responses 710 may be provided, each of one of several categories 720. Categories 720 may include empathy for the consumer's situation, sympathy, humor, incentive, neutral information, congratulatory, excited, etc.

The relevancy scoring system 100 may take into account the variables 270 and sub-variables 280 when recommending a recommended response 710. For example, the relevancy scoring system 100 may suggest using humor or an immediately actionable incentive when communicating with an ESTP personality (under the Myers-Briggs personality model), while suggesting an empathic or sympathetic response when communicating with an INFJ personality. However, although recommended response 710 have been described herein as being generated with reference to personality sub-variables 280, it will be understood by those of skill in the art that any of the variables 270 or sub-variables 280 may be taken into account by the relevancy scoring system 100 when generating a recommended response 710. Further, for each category 720 of suggested response, the user interface 104 may include examples of that category of response. For example, a neutral recommended response 710 may include recommended text 730 of “Have you considered Car Company?” It is contemplated that the recommended text 730 may be generated by the relevancy scoring system 100 and take into account and respond to the post text 212 and the media 210 of the post 120. Alternatively, the recommended text may be example text that may be modified by the user 140. Additionally, the recommended response for a category 720 may include a predicted success rate statistic 740 for that consumer. In order to generate the predicted success rate statistic 740, the relevancy scoring system 100 may measure the sentiment of the consumer response to the category of the recommended response or the actual response made by the user 104.

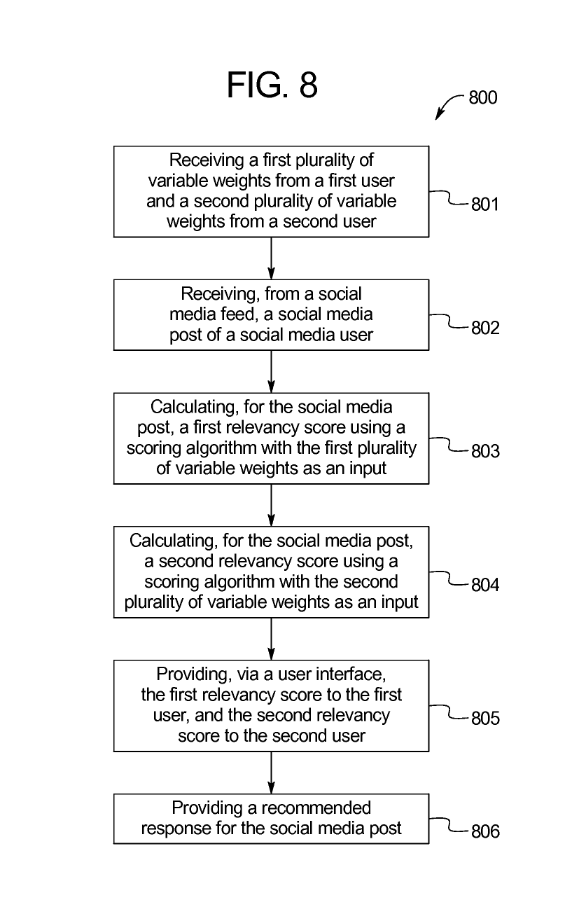

In an embodiment, shown in FIG. 8, the relevancy score system 100 includes a controller 101 that executes a relevancy scoring method 800 including the steps of: at step 801, receiving a first plurality of variable weights from a first user and a second plurality of variable weights from a second user, wherein each variable weight corresponds to a variable of a set of variables; at step 802, receiving, from a social media feed, a social media post of a social media user; at step 803, calculating, for the social media post, a first relevancy score using a scoring algorithm with the first plurality of variable weights as an input; at step 804, calculating, for the social media post, a second relevancy score using a scoring algorithm with the second plurality of variable weights as an input; at step 805, providing, via a user interface, the first relevancy score to the first user, and the second relevancy score to the second user; and, at step 806, providing a recommended response for the social media post.

As described, in an embodiment, a set of variables 270 may include a person variable 271, an influence variable 272, a post variable 273, a location variable 274, and a conditions variable 275. However, it is contemplated that in other embodiments other sets of variables 270 may be used. For example, in an embodiment, a set of variables 270 includes a post variable 273, an influence variable 273, and a location variable 274. In another embodiment, a set of variables 270 includes a post variable 273, a person variable 271, and an influence variable 273. In an additional embodiment, a set of variables includes a person variable 271, an influence variable 273, and a location variable 274.

In another embodiment, a set of variables 270 includes a post variable 273, a person variable 271, and an influence variable 273. In an additional embodiment, a set of variables includes a person variable 271, an influence variable 273, and a location variable 274. In an embodiment, a set of variables includes an influence variable 272, a post variable 273, a location variable 274, and a conditions variable 275. In another embodiment, a set of variables includes a person variable 271, a post variable 273, a location variable 274, and a conditions variable 275. In an embodiment, a set of variables includes a person variable 271, an influence variable 272, a location variable 274, and a conditions variable 275. In a further embodiment, a set of variables includes a person variable 271, an influence variable 272, a post variable 273, and a conditions variable 275. In yet another embodiment, a set of variables includes a person variable 271, an influence variable 272, a post variable 273, and a location variable 274.

Aspects of the systems and methods described herein are controlled by one or more controllers 101. The one or more controllers 101 may be adapted run a variety of application programs, access and store data, including accessing and storing data in associated databases, and enable one or more interactions via the relevancy scoring system 100. Typically, the one or more controllers 101 are implemented by one or more programmable data processing devices. The hardware elements, operating systems, and programming languages of such devices are conventional in nature, and it is presumed that those skilled in the art are adequately familiar therewith.

For example, the one or more controllers 101 may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories include a main memory 102, such as a dynamic random access memory (DRAM) and cache, as well as a read only memory, such as a PROM, EPROM, FLASH-EPROM, or the like. The system may also include any form of volatile or non-volatile memory 102. In operation, the main memory 102 stores at least portions of instructions for execution by the CPU and data for processing in accord with the executed instructions.

The one or more controllers 101 may also include one or more input/output interfaces for communications with one or more processing systems. One or more such interfaces may include a network interface 103 to enable communications via a network, e.g., to enable sending and receiving instructions electronically. The communication links may be wired or wireless.

The one or more controllers 101 may further include appropriate input/output ports for interconnection with one or more output displays (e.g., monitors, printers, touchscreen, motion-sensing input device, etc.) and one or more input mechanisms (e.g., keyboard, mouse, voice, touch, bioelectric devices, magnetic reader, RFID reader, barcode reader, touchscreen, motion-sensing input device, etc.) serving as one or more user interfaces 104 for the processor. For example, the one or more controllers 101 may include a graphics subsystem to drive the output display. The links of the peripherals to the system may be wired connections or use wireless communications.

Although summarized above as a PC-type implementation, those skilled in the art will recognize that the one or more controllers 101 also encompasses systems such as host computers, servers, workstations, network terminals, and the like. Further one or more controllers 101 may be embodied in a device, such as a mobile electronic device, like a smartphone or tablet computer. In fact, the use of the term processor is intended to represent a broad category of components that are well known in the art.

Hence aspects of the systems and methods provided herein encompass hardware and software for controlling the relevant functions. Software may take the form of code or executable instructions for causing a controller 101 or other programmable equipment to perform the relevant steps, where the code or instructions are carried by or otherwise embodied in a medium readable by the processor or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a controller 101 for execution.

It should be noted that various changes and modifications to the presently preferred embodiments described herein will be apparent to those skilled in the art. Such changes and modifications may be made without departing from the spirit and scope of the present invention and without diminishing its attendant advantages.

1. A computer-implemented method performed by a processor for identifying social media posts relevant to a user, the method comprising the steps of:
receiving a first plurality of variable weights from a first user and a second plurality of variable weights from a second user, wherein each variable weight corresponds to a variable of a set of variables;
receiving, from a social media feed, a social media post of a social media user;
calculating, for the social media post, a first relevancy score using a scoring algorithm with the first plurality of variable weights as an input;
calculating, for the social media post, a second relevancy score using a scoring algorithm with the second plurality of variable weights as an input;
providing, via a user interface, the first relevancy score to the first user, and the second relevancy score to the second user.

2. The method of claim 1, the method further comprising:
receiving a relevancy score threshold from the first user; and
when the relevancy score exceeds the first relevancy score, notifying the first user of the social media post.

3. The method of claim 1, wherein the scoring algorithm calculates the first relevancy score by summing products of a value of each variable multiplied by the variable weight corresponding to the variable.

4. The method of claim 1, wherein the set of variables includes:
a post variable derived from content of the social media post;
a location variable derived from a location of the social media post; and
an influence variable derived from the social media interactions of the social media user.

5. The method of claim 1, wherein the set of variables includes:
a post variable derived from content of the social media post;
a location variable derived from a location of the social media post;
an influence variable derived from the social media interactions of the social media user; and
a person variable derived from a social network profile of the social media user; and
a conditions variable derived from one or more conditions at the location of the social media post.

6. The method of claim 5, wherein a value of the post variable is increased in response to the presence of a keyword in the social media post.

7. The method of claim 5, wherein a value of the post variable is increased relative to a sentiment of the post.

8. The method of claim 5, wherein a value of the location variable is increased relative to the distance between a pre-determined location and the location of the social media post.

9. The method of claim 5, wherein a value of the influence variable is increased relative to a number of followers of the social media user.

10. The method of claim 5, wherein a value of the person variable is increased in response to a profile of the social media user matching a personality type.

11. The method of claim 5, wherein a value of the conditions variable is increased in response to weather at the location of the social media post.

12. The method of claim 1, the method further comprising:
providing a recommended response for the social media post.

13. The method of claim 12, wherein the recommended response includes a recommended category of response.

14. The method of claim 12, wherein the recommended response includes a recommended text example.

15. The method of claim 12, wherein the recommended response includes a predicted rate of success of the response.

16. The method of claim 1 wherein each of the first plurality of variable weights received from the first user and the second plurality of variable weights received from the second user are independently adjustable in real-time.

17. The method of claim 1 wherein the social media feed comprises any selection of posts from a social media platform.
